(19) United States
(12) Patent Application Publication
(10) Pub. No.: US 2018/0101688 A1
(43) Pub. Date: Apr. 12, 2018

(54) TRUST-ENHANCED ATTRIBUTE-BASED ENCRYPTION

(71) Applicant: Intel Corporation, Santa Clara, CA (US)

(72) Inventors: David John Zage, Fremont, CA (US); Eve M. Schooler, Portola Valley, CA (US); Moreno Ambrosin, Padova (IT)

(21) Appl. No.: 15/290,655

(22) Filed: Oct. 11, 2016

(51) Int. Cl. G06F 21/62; H04L 9/30; H04L 9/08

(52) U.S. Cl. CPC G06F 21/62; H04L 9/3073; H04L 2209/12; H04L 9/0894; H04L 2209/24; H04L 9/083

(57) ABSTRACT

Embodiments are directed to protecting, and recovering protected information, with attribute-based encryption. a predefined attribute policy defines one or more combinations of recipient attributes that entitle the recipient entity to attain access to the protected information. A set of at least one trust criterion is derived from the predefined attribute policy. The at least one trust criterion represents a measure of trust attainable by at least one combination or relationship of the plurality of recipient attributes. At least one trust assessment is produced based on application of the predefined attribute policy to the plurality of recipient attributes. The at least one trust assessment is compared to the at least one trust criterion, the result of the comparison providing an access grant to a decryption process to recover the protected information from the cyphertext.

### TECHNICAL FIELD

Embodiments described herein generally relate to computer security, more particularly, to cryptographic operations to be executed by a processor of a computer system.

### BACKGROUND

Attribute Based Encryption (ABE) is a public-key-based cryptographic technique in which the secret key of the user and the ciphertext is dependent on the user's attributes. ABE is attractive because it is considered self-protecting: it embeds the access control policy directly in the encrypted data or in the key used for the encryption.

ABE may be used in scenarios such as creating self-protecting electronic records (e.g., in a healthcare context, for instance, ABE may limit access to records based on role attributes such as nurse, doctor, or primary patient). ABE may also be used for data storage when the content creator/encryptor is no longer present (e.g., confidential cloud storage for group projects), or when the creator is only intermittently present (e.g. Internet-of-things (IoT) use cases such as transportation).

Generally, ABE employs an access structure, which may be tree-based, for example, which must be satisfied with a given set of attributes in order to permit decryption of the data. The access structure allows the encryptor to specify which attributes may decrypt the data. Attributes may be used in various combinations, such as conjunctive (AND), disjunctive (OR), and k-of-n.

One drawback to ABE is that, as the number of attributes used in the access structure increases, the encryption and decryption processes become slower and increasingly computationally resource-intensive. Moreover, in conventional ABE systems, as the attributes governing access may change (e.g., certain groups may become prohibited from viewing protected data), whereas others may be added (e.g., roles that did not previously exist but now have a need to access the data), the data needs to be re-encrypted to reflect the changed attribute-based access criteria. Practical solutions are needed to address these, and other, challenges.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a high-level diagram illustrating examples of various types of computing platforms on which aspects of the described techniques may be implemented according to some embodiments.

FIG. 2 is a block diagram illustrating an exemplary system architecture of a processor-based computing device according to an embodiment.

FIG. 3 is a diagram illustrating an exemplary hardware and software architecture of a computing device such as the one depicted in FIG. 2, in which various interfaces between hardware components and software components are shown.

FIG. 4 is a block diagram illustrating examples of processing devices that may be implemented on a computer system, such as the computer system described with reference to FIGS. 2-3, according to some embodiments.

FIG. 5 is a block diagram illustrating example components of a CPU as one of the processing devices depicted in FIG. 4, according to various embodiments.

FIG. 6 is a block diagram illustrating the architecture and operation of a system for protecting information according to some embodiments.

FIG. 7 is a block diagram illustrating the structure and operation of an attribute distiller of the system of FIG. 6 according to some embodiments.

FIG. 8 is a diagram illustrating the structure and operation of an encryptor of the system of FIG. 6 according to an example embodiment.

FIG. 9 is a diagram illustrating the architecture and operation of a system for recovering the protected information according to some embodiments.

FIG. 10 is a diagram illustrating the structure and operation of an attribute evaluator of the system of FIG. 9 according to an example embodiment.

FIG. 11 is a diagram illustrating the structure and operation of a decryptor of the system of FIG. 9 according to some embodiments.

### DETAILED DESCRIPTION

Aspects of the embodiments are directed to encryption and decryption operations that are to be performed by a processor-based computing platform. The computing platform may be one physical machine, or may be distributed among multiple physical machines, such as by role or function, or by process thread in the case of a cloud computing distributed model. In various embodiments certain operations may run in virtual machines that in turn are executed on one or more physical machines. It will be understood by persons of skill in the art that features of the invention may be realized by a variety of different suitable machine implementations.

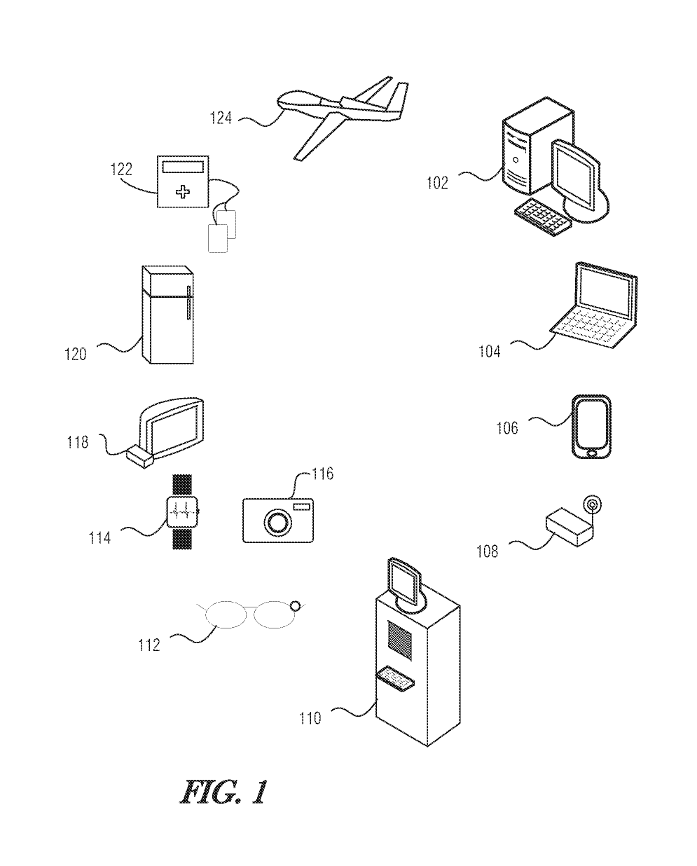

FIG. 1 is a high-level diagram illustrating examples of various types of computing platforms on which aspects of the embodiments may be implemented. The computing platforms include personal computers, such as desktop personal computer (PC) 102, laptop 104, smartphone/tablet 106, and the like. Other types of information devices, such as networking appliance 108, which represents a switch, router, access point, etc., are computing platforms that are also contemplated. Industrial equipment 110, such as control systems, automated tooling, motor/robotics controls, programmable logic controllers, are also types of computing platforms on which aspects of the embodiments may be implemented. Computing platforms may also be implemented as consumer-electronic devices, such as smart glasses 112, smartwatch 114, digital camera 116, and media device 118, such as a set-top box as depicted, audio playback system, etc. Appliance 120 may also contain a computing system such as, for instance, an Internet of Things (IOT) node. Medical device 122 may contain an embedded computing platform. Likewise vehicle 124 may also contain one or more computing platforms. Each computing platform may include a processor-based system, e.g., a machine capable of executing instructions (sequential or otherwise) that specify actions to be taken by that machine, as described in greater detail below.

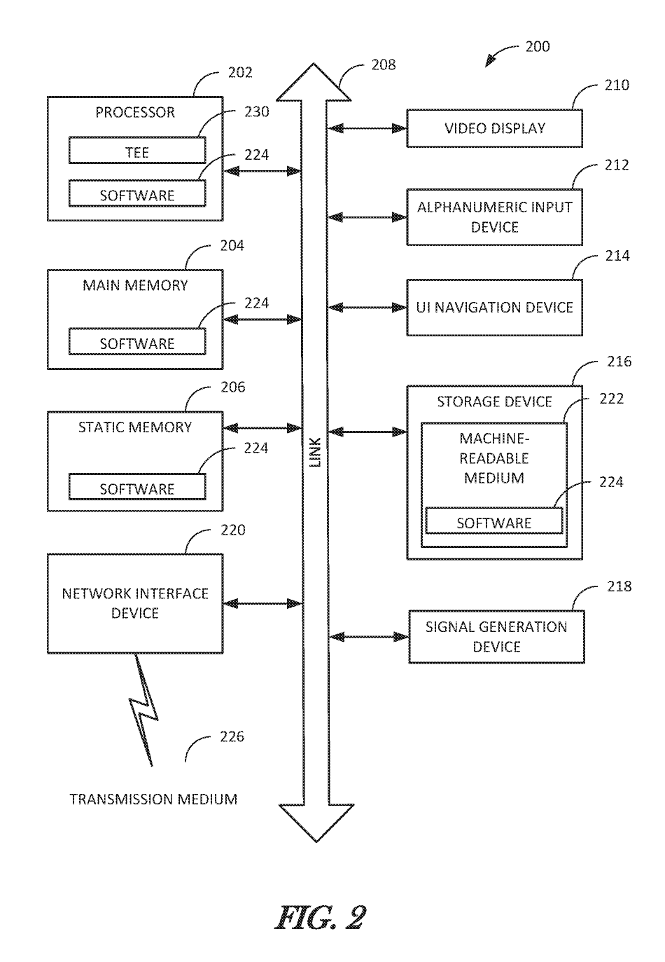

FIG. 2 is a block diagram illustrating a computer system in the example form of a general-purpose machine that may be configured with one or more modules to operate as a special-purpose machine. In a networked deployment, the computer system may operate in the capacity of either a server or a client machine in server-client network environments, or it may act as a peer machine in peer-to-peer (or distributed) network environments.

Example computer system 200 includes at least one processor 202 (e.g., a central processing unit (CPU), a graphics processing unit (GPU) or both, processor cores, compute nodes, etc.), a main memory 204 and a static memory 206, which communicate with each other via a link 208 (e.g., bus). The computer system 200 may further include a video display unit 210, an alphanumeric input device 212 (e.g., a keyboard), and a user interface (UI) navigation device 214 (e.g., a mouse). In one embodiment, the video display unit 210, input device 212 and UI navigation device 214 are incorporated into a touch screen display. The computer system 200 may additionally include a storage device 216 (e.g., a drive unit), a signal generation device 218 (e.g., a speaker), a network interface device (NID) 220, and one or more sensors (not shown), such as a global positioning system (GPS) sensor, compass, accelerometer, or other sensor.

The storage device 216 includes a machine-readable medium 222 on which is stored one or more sets of data structures and instructions 224 (e.g., software) embodying or utilized by any one or more of the methodologies or functions described herein. The instructions 224 may also reside, completely or at least partially, within the main memory 204, static memory 206, and/or within the processor 202 during execution thereof by the computer system 200, with the main memory 204, static memory 206, and the processor 202 also constituting machine-readable media.

While the machine-readable medium 222 is illustrated in an example embodiment to be a single medium, the term “machine-readable medium” may include a single medium or multiple media (e.g., a centralized or distributed database, and/or associated caches and servers) that store the one or more instructions 224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

NID 220 according to various embodiments may take any suitable form factor. In one such embodiment, NID 220 is in the form of a network interface card (NIC) that interfaces with processor 202 via link 208. In one example, link 208 includes a PCI Express (PCIe) bus, including a slot into which the NIC form-factor may removably engage. In another embodiment. NID 220 is a network interface circuit laid out on a motherboard together with local link circuitry, processor interface circuitry, other input/output circuitry, memory circuitry, storage device and peripheral controller circuitry, and the like. In another embodiment, NID 220 is a peripheral that interfaces with link 208 via a peripheral input/output port such as a universal serial bus (USB) port. NID 220 transmits and receives data over transmission medium 226, which may be wired or wireless (e.g., radio frequency, infra-red or visible light spectra, etc.), fiber optics, or the like.

System 200 may also include a trusted execution environment (TEE) 230 which, as depicted, may be formed or configured as part of processor 202. TEE 230 is described in greater detail below.

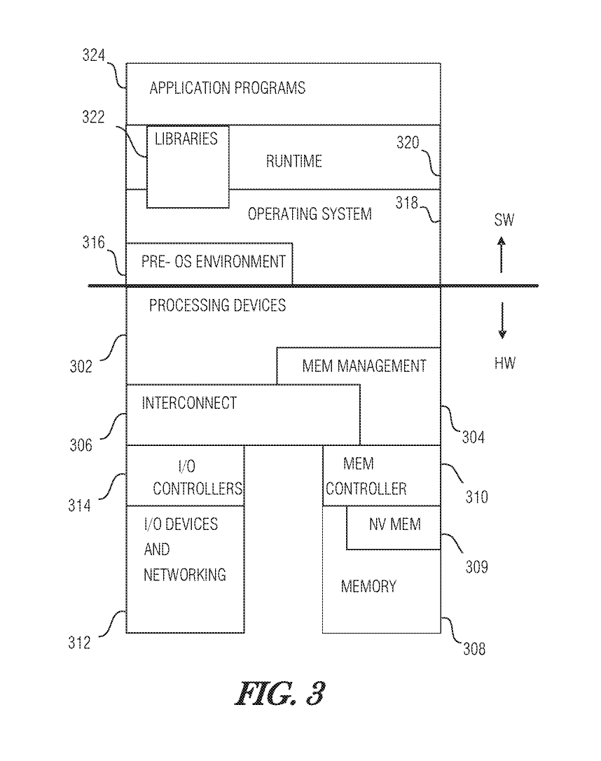

FIG. 3 is a diagram illustrating an exemplary hardware and software architecture of a computing device such as the one depicted in FIG. 2, in which various interfaces between hardware components and software components are shown. As indicated by HW, hardware components are represented below the divider line, whereas software components denoted by SW reside above the divider line. On the hardware side, processing devices 302 (which may include one or more microprocessors, digital signal processors, etc., each having one or more processor cores, are interfaced with memory management device 304 and system interconnect 306. Memory management device 304 provides mappings between virtual memory used by processes being executed, and the physical memory. Memory management device 304 may be an integral part of a central processing unit which also includes the processing devices 302.

Interconnect 306 includes a backplane such as memory, data, and control lines, as well as the interface with input/output devices, e.g., PCI, USB, etc. Memory 308 (e.g., dynamic random access memory—DRAM) and non-volatile memory 309 such as flash memory (e.g., electrically-erasable read-only memory—EEPROM, NAND Flash, NOR Flash, etc.) are interfaced with memory management device 304 and interconnect 306 via memory controller 310. This architecture may support direct memory access (DMA) by peripherals in some embodiments. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 312, which interface with interconnect 306 via corresponding I/O controllers 314.

On the software side, a pre-operating system (pre-OS) environment 316, which is executed at initial system start-up and is responsible for initiating the boot-up of the operating system. One traditional example of pre-OS environment 316 is a system basic input/output system (BIOS). In present-day systems, a unified extensible firmware interface (UEFI) is implemented. Pre-OS environment 316, is responsible for initiating the launching of the operating system, but also provides an execution environment for embedded applications.

Operating system (OS) 318 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 318 provides device drivers, and a variety of common services such as those that facilitate interfacing with peripherals and networking, that provide abstraction for application programs so that the applications do not need to be responsible for handling the details of such common operations. Operating system 318 additionally provides a graphical user interface (GUI) that facilitates interaction with the user via peripheral devices such as a monitor, keyboard, mouse, microphone, video camera, touchscreen, and the like.

Runtime system 320 implements portions of an execution model, including such operations as putting parameters onto the stack before a function call, the behavior of disk input/output (I/O), and parallel execution-related behaviors. Runtime system 320 may also perform support services such as type checking, debugging, or code generation and optimization.

Libraries 322 include collections of program functions that provide further abstraction for application programs. These include shared libraries, dynamic linked libraries (DLLs), for example. Libraries 322 may be integral to the operating system 318, runtime system 320, or may be added-on features, or even remotely-hosted. Libraries 322 define an application program interface (API) through which a variety of function calls may be made by application programs 324 to invoke the services provided by the operating system 318. Application programs 324 are those programs that perform useful tasks for users, beyond the tasks performed by lower-level system programs that coordinate the basis operability of the computing device itself.

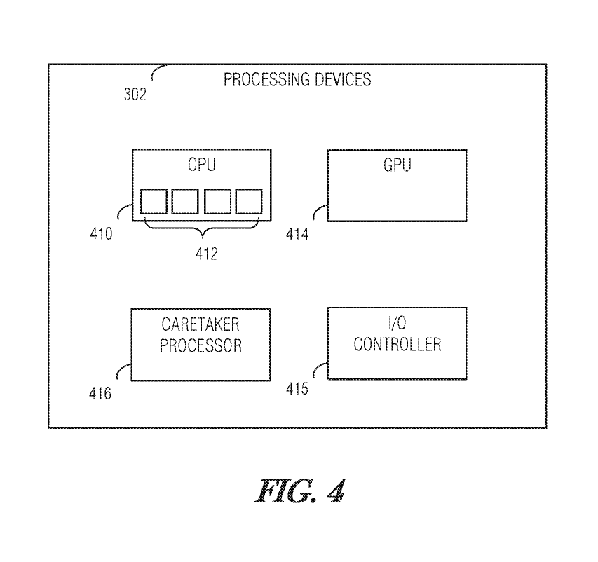

FIG. 4 is a block diagram illustrating processing devices 302 according to some embodiments. CPU 410 may contain one or more processing cores 412, each of which has one or more arithmetic logic units (ALU), instruction fetch unit, instruction decode unit, control unit, registers, data stack pointer, program counter, and other essential components according to the particular architecture of the processor. As an illustrative example, CPU 410 may be a x86-type of processor. Processing devices 302 may also include a graphics processing unit (GPU) 414. In these embodiments, GPU 414 may be a specialized co-processor that offloads certain computationally-intensive operations, particularly those associated with graphics rendering, from CPU 410. Notably, CPU 410 and GPU 414 generally work collaboratively, sharing access to memory resources, I/O channels, etc.

Processing devices 302 may also include caretaker processor 416 in some embodiments. Caretaker processor 416 generally does not participate in the processing work to carry out software code as CPU 410 and GPU 414 do. In some embodiments, caretaker processor 416 does not share memory space with CPU 410 and GPU 414, and is therefore not arranged to execute operating system or application programs. Instead, caretaker processor 416 may execute dedicated firmware that supports the technical workings of CPU 410, GPU 414, and other components of the computer system. In some embodiments, caretaker processor is implemented as a microcontroller device, which may be physically present on the same integrated circuit die as CPU 410, or may be present on a distinct integrated circuit die. Caretaker processor 416 may also include a dedicated set of I/O facilities to enable it to communicate with external entities. In one type of embodiment, caretaker processor 416 is implemented using a manageability engine (ME) or platform security processor (PSP). Input/output (I/O) controller 415 coordinates information flow between the various processing devices 410, 414, 416, as well as with external circuitry, such as a system interconnect.

In one embodiment, two or more of processing devices 302 depicted are formed on a common semiconductor substrate.

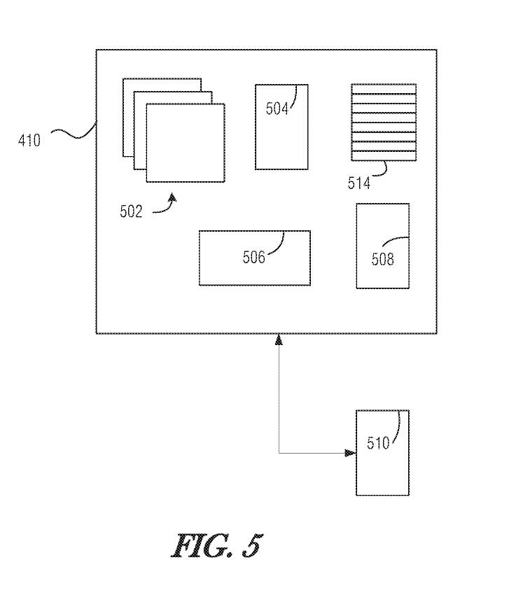

FIG. 5 is a block diagram illustrating example components of CPU 410 according to various embodiments. As depicted, CPU 410 includes one or more cores 502, cache 504, and CPU controller 506, which coordinates interoperation and tasking of the core(s) 502, as well as providing an interface to facilitate data flow between the various internal components of CPU 410, and with external components such as a memory bus or system interconnect. In one embodiment, all of the example components of CPU 410 are formed on a common semiconductor substrate.

CPU 410 includes non-volatile memory 508 (e.g., flash, EEPROM, etc.) for storing certain portions of foundational code, such as initialization code, and code that establishes a trusted execution environment (TEE). Also, CPU 410 may be interfaced with an external (e.g., formed on a separate IC) non-volatile memory device 510 that stores foundational code that is launched by the initialization module, such as system BIOS or UEFI code. Notably, some of the non-volatile memory may be accessible only to the TEE, and is therefore secured from malicious processes in the event that the system is compromised.

In the embodiment depicted, CPU 410 is configured to provide a trusted Execution Environment (TEE). Trusted applications or other code running in a TEE have access to the full power of a device's main processor and memory, while hardware isolation protects these from user-installed apps running in a main operating system. Software and cryptographic isolation inside the TEE protect the trusted applications contained within from each other. As an example, Software Guard Extensions (SGX) protect selected code and data from Intel® disclosure or modification. Applications may be partitioned into CPU-hardened “enclaves” or protected areas of execution that increase security even on compromised platforms. The protected portion of an application is loaded into an enclave where its code and data are measured. A report is sent to the remote application owner's server, which in turn may validate that the enclave report was generated by an authentic processor. Upon verification of the enclave identity, the remote party may trust the enclave and securely provision keys, credentials, or data.

Examples, as described herein, may include, or may operate on, logic or a number of components, circuits, engines, or modules, which for the sake of consistency are termed engines, although it will be understood that these terms may be used interchangeably. Engines may be hardware, software, or firmware communicatively coupled to one or more processors in order to carry out the operations described herein. Engines may be hardware engines, and as such engines may be considered tangible entities capable of performing specified operations and may be configured or arranged in a certain manner. In an example, circuits may be arranged (e.g., internally or with respect to external entities such as other circuits) in a specified manner as an engine. In an example, the whole or part of one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein.

Considering examples in which engines are temporarily configured, each of the engines need not be instantiated at any one moment in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

One aspect of the embodiments is directed to an attribute-based cryptosystem in which a distilled set of at least one attribute is derived from the full set of attributes upon which the attribute-based encryption is founded. The full set of attributes in the present context is analogous to the set of attributes that would have been used in a traditional ABE algorithm as the primary (but not necessarily exclusive) foundation for ABE encryption. In some embodiments, the distilled set of one or more attributes may be considered as one or more trust criterion, or measure of trust of an information-decrypting party.

In some examples, the distilled set of attributes is a single “trust” attribute. In other examples, the distilled set may include a plurality of attributes that are individually, or collectively, based on the full set of attributes. The cryptographic algorithm is executed conditionally based upon a set of trust criteria defined for the distilled set of attributes. In some examples, other than the trust criteria upon which execution of the encryption or decryption operations are conditioned, the cryptographic algorithm itself is distinct from the attributes.

Advantageously, the use of a distilled set of attributes, which is a smaller set than the full set of attributes, improves the computational speed of the data encryption and decryption processes. The use of a distilled set of attributes for ABE may streamline encryption and decryption computations as those processes would otherwise tend to present an increasing computational load as the number of attributes used increases. It allows for greater expressive power in describing the relationships between attributes (e.g., generalized Boolean expression) rather than merely a list of attributes which must be satisfied to provide data access.

Furthermore, the distilled set of attributes, and the trust criteria may be changed without having to re-encrypt the data when the attributes or their relationships change. The use of the distilled set of attributes according to some embodiments supports the use of a large universe of attributes, upon which access to the information is to be conditioned, that do not have to be specified at the time the data is created/encrypted. Similarly, the cryptographic keys and algorithms may be changed independently from the attribute criteria.

Aspects of the embodiments are applicable in Ciphertext-Policy ABE (CP-ABE), Key-Policy ABE (KP-ABE), or Hybrid ABE. For the sake of brevity, examples described below are in the context of a CP-ABE implementation; however, it will be understood that the inventive principles may be readily adapted for other types of ABE.

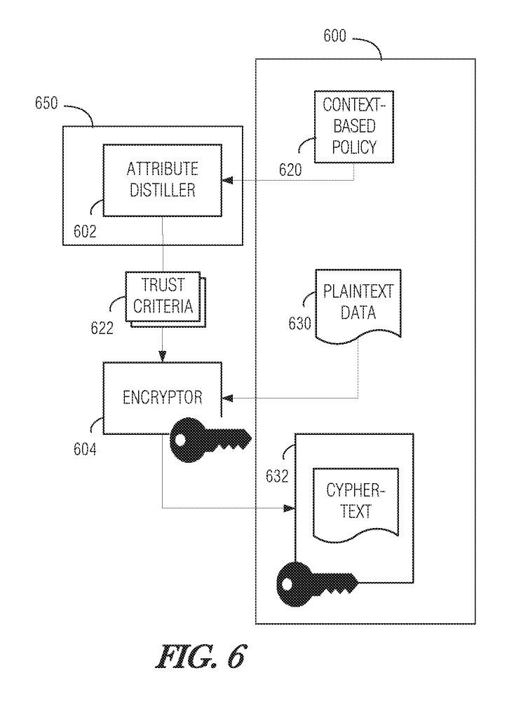

FIG. 6 is a block diagram illustrating the architecture and operation of a system for protecting information of owner 600 according to some embodiments. Owner 600 in the present context refers to an entity that has possession of the information and an intention to share or transfer the information to a recipient entity. Notably, owner 600 may or may not be the owner of the information in the legal sense. The information to be protected may include documents, personal information, software code, media content, and any other objects that are storable on a computer-readable medium. For the sake of brevity, the information to be protected may be referred to simply as data and, more particularly, as plaintext data when it is readable (unencrypted), and cyphertext when it is encrypted.

As depicted, the system includes attribute distiller 602 and encryptor 604. These engines may be combined on a single computing platform, or they may be separated. Also, engines 602 and 604 may be operated by a common entity, or by different entities. In the latter case, for example, attribute distiller 602 may be operated by protection manager 650, while encryptor 604 may be operated by the owner 600 of the data 630 to be protected. In the former example, both, the attribute distiller 602, and the encryptor 604 may be operated by protection manager 650. Protection manager 650 may be a trusted entity that is responsible for assessing the attributes of potential recipients to assess their qualification to obtain ABE decryption keys.

Attribute distiller 602 is constructed, programmed, or otherwise configured, to produce one or more trust criteria 622, which may include distilled attributes, based on an input of a context-based attribute policy 620. To illustrate the distillation of the attributes, consider an example in which various combinations of attributes A, B, C, and D of a receiving party are authorized to permit the receiving party to access protected information. For instance the following expression, which may be included as part of context-based policy 620, defines various combinations of attributes with which access to protected information may be attained:
A AND (B OR C) OR ((B OR C)>=D)

In this example, the following combinations of attributes may suffice to grant access to the protected content.

A AND B

A AND C

B>=D

C>=D

According to a related embodiment, a measure of trust may be associated with each combination or relationship. For instance:

TABLE 1

| Combination/Relationship | Trust Score |
|---|---|
| A AND B | 80 |
| A AND C | 90 |
| B >= D | 75 |
| C >= D | 85 |

The association of the trust score may be predefined, or formulaically derived, for example. In another example, the trust score may be conditioned on various context indicia, such as a recipient's current activity, place, and time, for instance. Accordingly, for each combination or relationship of attributes, the trust score may vary based on the context in which the protected information is to be accessed.

In various embodiments, trust criteria 622 may be represented as a single attribute-like construct such as an assessed contextual trust score of X, where X is a set value. In the simplified example above, the contextual trust score of trust criteria 622 may be a trust threshold that is to be met by the attributes of the recipient entity to gain access to the protected information. The trust threshold may be computationally derived by attribute distiller 602 based on the context-based policy 620, or directly set by owner 600 or a security-policy administrator, for instance. In the latter case, the direct setting of the trust criteria may supersede a computationally-derived set of trust criteria. To illustrate, trust criteria 622 may be defined simply as a trust score >=75, which in this case is greater than or equal to the minimum trust score from among the exemplified combinations of attributes. In a related embodiment, trust criteria 622 may include multiple items, such as trust score of at least 75 for context 1, trust score of at least 85 for context 2.

Encryptor 604 is programmed, or otherwise configured, to encrypt plaintext data 630 using an asymmetric key to produce cyphertext 632, which is accessible only to a party having the counterpart asymmetric key. In a related example, the cyphertext 632 is encrypted based in part on trust criteria 622.

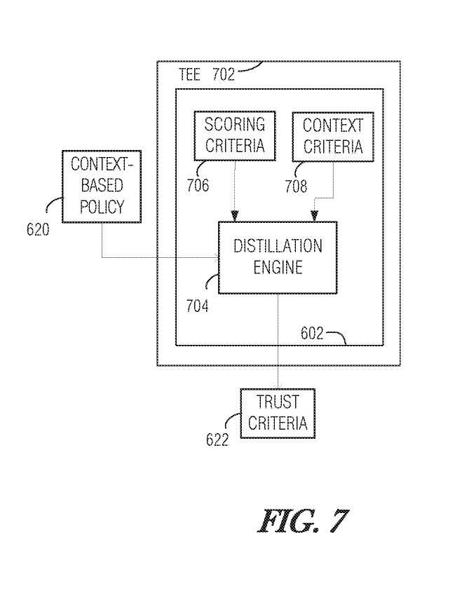

FIG. 7 is a block diagram illustrating the structure and operation of attribute distiller 602 in greater detail. According to the embodiment depicted, attribute distiller 602 is executed in TEE 702. Distillation engine 704 includes program logic and processing circuitry that executes the program logic, which in turn causes the processing circuitry to read context-based policy 620, and generate trust criteria 622 based on scoring criteria 706 and context criteria 708. Scoring criteria 706 includes rules (which may be heuristic rules in some examples), a lookup table, decision tree, or other suitable data structure, that defines the parameters for determining relative weights, or other measures applicable to combinations between attributes as defined in the context-based policy 620. The embodiment described in Table 1 above illustrates a lookup table-type example. In related embodiments, as discussed above, different scoring criteria values may be associated with the context-based policy attributes based of different possible contexts.

Context criteria 708 includes rules (which may be heuristic rules in some examples), a lookup table, decision tree, or other suitable data structure, that defines various contexts. The contexts may be defined according to intended uses of the protected information. Context definitions may include indicia of the activity (e.g., based on computing platform type, applications running on the computing platform, movement of the computing platform, user input patterns, location, time of day, and any other suitable parameters).

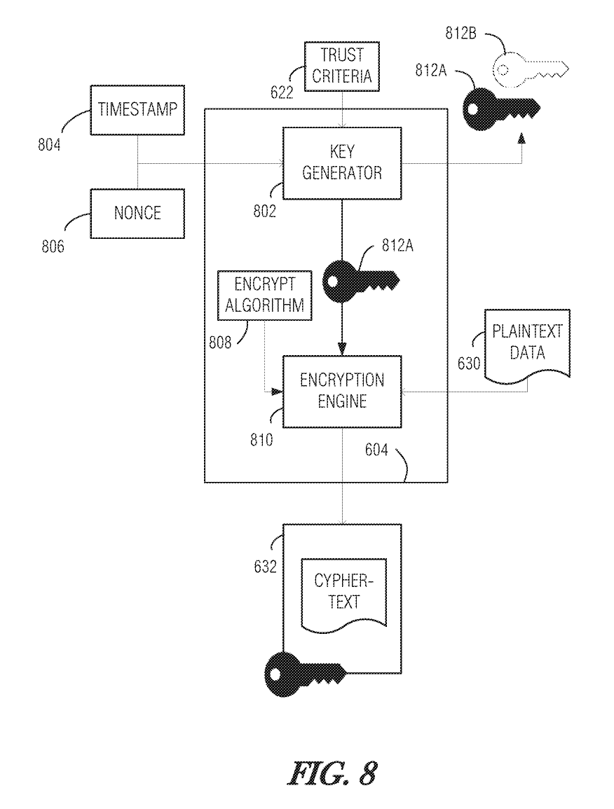

FIG. 8 is a diagram illustrating the structure and operation of encryptor 604 in greater detail according to an example embodiment. As depicted, encryptor 604 includes key generator 802, encryption algorithm 808, and encryption engine 810. In an example, key generator 802 is constructed, programmed, or otherwise configured, to generate an ABE cryptographic keys 812A and 812B, such as asymmetric, or public/private keys, that are based on trust criteria 622. As illustrated key 812A is used for encryption, whereas key 812B is used for decryption. Decryption key 812B may be securely provided to protection manager 650 for use in decrypting the cyphertext. In related examples, key generator 802 may also incorporate additional items into the key pairs 812, such as timestamp 804, nonce 806, and the like.

Encryption engine 810 executes encryption algorithm 808 to encrypt plaintext data 630 with the private encryption key 812A generated by key generator 802. The result of this operation is cyphertext 632.

In a related embodiment, key generator 802 is operated by a separate entity, such as a key-generation service, that is provided with trust criteria 622, from which the key pair 812 is to be generated.

The following describes operation of the system of FIGS. 6-8. Attribute distiller 602 receives context-based policy 620 from owner 600, or from a policy administrator entity. Notably, attribute distiller 602 does not need the information to be protected, e.g., plaintext data 630. Distillation engine 704 of attribute distiller 602 reads context-based policy 620, and applies scoring criteria 706 and context criteria 708 to produce a distilled set of attributes, such as trust criteria 622 in the present example. Trust criteria 622 may include a trust threshold, for example, that must be met by the recipient entity in order to gain access to the protected plaintext data 630.

In a related example, trust criteria 622 may be defined by owner 600 or by the policy administrator, and this definition may supersede any autonomously-generated trust criteria.

Encryptor 604 uses the trust criteria 622 to create an ABE-encrypted cyphertext 632 of plaintext data 630. For example, in an embodiment where the trust criteria 622 includes, or consists of, a trust threshold, the trust threshold itself may be used as a seed for generation of an encryption key to encrypt plaintext data 630 into cyphertext 632. Key generator 802 generates a key pair that is based at least in part on the trust criteria 622. The decryption key 812B is provided to an attribute evaluator (discussed below) for generating an access grant if it determines that the recipient entity is entitled to access the protected information based on the attributes of the recipient entity. The encryption key is provided to encryption engine 810, which uses it according to encryption algorithm 808 to produce cyphertext 632 from plaintext data 630. Cyphertext 632 may thereafter be provided to a recipient entity.

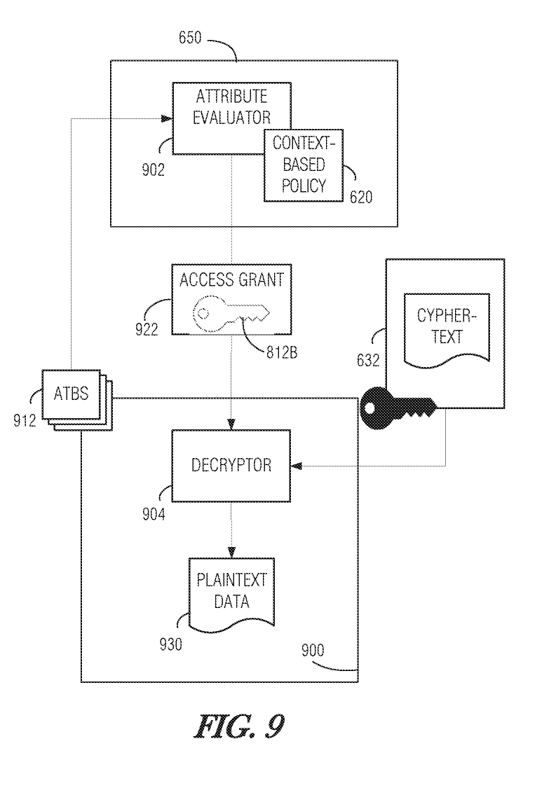

FIG. 9 is a diagram illustrating the architecture and operation of a system for recovering the protected information according to some embodiments. The system operates to decrypt cyphertext 632 for recipient entity 900, which has attributes 912, provided that the attributes 912 meet context-based policy 620. As depicted, the system includes attribute evaluator 902, and decryptor 904. Attribute evaluator 902 may be part of protection manager 650 according to some embodiments.

Notably, in various embodiments, protection manager 650 may be centralized, or geographically distributed. In an example of a distributed arrangement, attribute distiller 602 and attribute evaluator 902 may be hosted on distinct computing platforms. In this type of arrangement, context-based policy 620 is shared between attribute distiller 602 and attribute evaluator 902 via a secure channel.

Attribute evaluator 902 is programmed, or otherwise configured, to evaluate the attributes 912 of recipient entity 900 against the context-based policy 620, to produce one or more measures of trust, and to compare the one or more measures of trust against the trust criteria 622 to produce an access grant determination 922 (which may include decryption key 812B) and represents the one or more measures of trust of the recipient entity 900 meeting trust criteria 622.

Decryptor 904 is programmed, or otherwise configured, to decrypt cyphertext 632 based on access grant 922, e.g., using decryption key 812B, to produce plaintext data 930 for use by recipient entity 900.

Decryptor 904 may be operated by recipient entity 900 as shown, or by a trusted entity that is configured to pass plaintext data 930 to recipient entity 900. In another related embodiment, decryptor 904 may be incorporated with attribute evaluator 902 as part of protection manager 650.

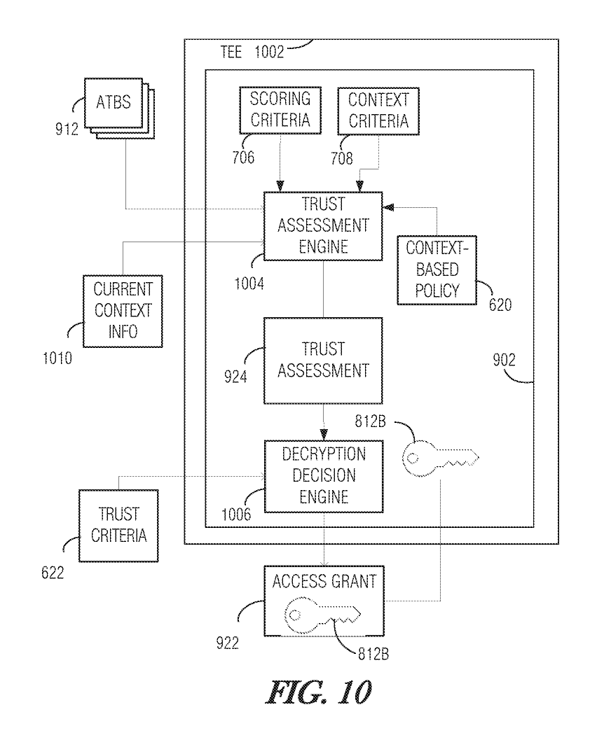

FIG. 10 is a diagram illustrating the structure and operation of attribute evaluator 902 according to an example embodiment. Attribute evaluator 902 may be executed in TEE 1002, which may be the same TEE as TEE 702, or a different TEE. Attribute evaluator 902 includes trust assessment engine 1004, which accesses attributes 912 of the recipient entity 900, as well as the current context information 1010. The current context information 1010 includes such items of information as the current activity, time, location, etc. The current context information 1010 may be determined by a context engine (not shown) using any suitable technique, whether currently known, or arising in the future. Trust assessment engine 1004 also accesses context-based policy 620, as well as scoring criteria 706 and context criteria 708. Trust assessment engine 1004 is configured to determine which scoring criteria is applicable from among multiple sets of scoring criteria that may be defined or derivable for different contexts. To this end, current context information 1010 is compared against context criteria 708. A lookup table, decision tree, heuristic rules, or other suitable decision mechanism may be used to select the applicable context-specific scoring criteria 706. The selected scoring criteria 706 is applied to attributes 912 and context-based policy 620 to determine a trust assessment 924.

In operation, Application of context-based policy 620 to the attributes 912 determines whether the attributes 912 include combinations of attributes that represent some defined level of trust. For example, application of context-based policy 620 may determine if a combination or relationship among attributes 912 is defined in a row of Table 1, and application of scoring criteria 706 determines the associated trust score from the right-hand column of Table 1. Accordingly, trust assessment 924 may be a maximum trust score that combinations/relationships among attributes 912 may achieve according to the context-based policy 620 and scoring criteria 706 for the present context.

Decryption decision engine 1006 is configured to compare the trust assessment 924 against trust criteria 622. If the trust criteria 622 is met (e.g., if the trust assessment includes a score of 90 and if the trust criteria 622 specifies a trust threshold of greater than or equal to 80), access grant 922 is provided to decryptor 904. Access grant 922 may include decryption key 812B.

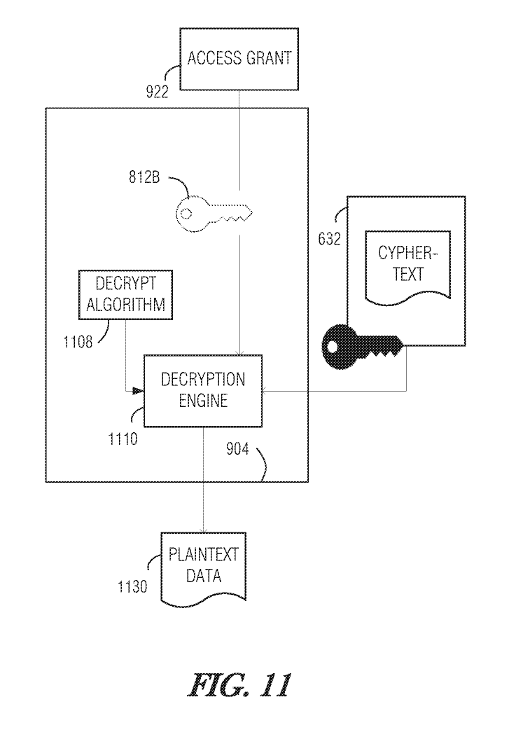

FIG. 11 is a diagram illustrating the structure and operation of decryptor 904 according to some embodiments. Decryptor 1110 executes decryption algorithm 1108 to produce plaintext data 1130, which is equivalent to recovering plaintext data 930, from cyphertext 632. To this end, decryptor engine 1110 uses decryption key 812B that is obtained from access grant 922.

### ADDITIONAL NOTES & EXAMPLES

Example 1 is a system for protecting information with attribute-based encryption, the system comprising: an attribute distiller configured to: access a predefined attribute policy that defines one or more combinations of a plurality of recipient attributes that entitle a recipient entity to attain access to protected information; and produce a set of at least one trust criterion derived from the predefined attribute policy, the at least one trust criterion representing a measure of trust attainable by at least one of the one or more combinations of the plurality of recipient attributes, the at least one trust criterion having fewer attributes than the plurality of recipient attributes; and an encryptor configured to encrypt the information to produce cyphertext, the cyphertext being based on the at least one trust criterion.

In Example 2, the subject matter of Example 1 optionally includes wherein the attribute policy is a context-based attribute policy defining a plurality of different measures of trust corresponding to different contexts.

In Example 3, the subject matter of any one or more of Examples 1-2 optionally include wherein the at least one trust criterion is a single trust criterion.

In Example 4, the subject matter of any one or more of Examples 1-3 optionally include wherein the at least one trust criterion includes a trust threshold value.

In Example 5, the subject matter of any one or more of Examples 1-4 optionally include a computing platform including a set of at least one processor, data storage circuitry, and input/output facilities, the computing platform configured to implement the attribute distiller and the encryptor.

In Example 6, the subject matter of any one or more of Examples 1-5 optionally include wherein the attribute distiller is implemented in a trusted execution environment.

Example 7 is a system for recovering protected information that is protected with attribute-based encryption, the system comprising: an attribute evaluator configured to: access a plurality of recipient attributes of a recipient entity; access a predefined attribute policy that defines one or more combinations of the plurality of recipient attributes that entitle the recipient entity to attain access to the protected information; and access a set of at least one trust criterion derived from the predefined attribute policy, the at least one trust criterion representing a measure of trust attainable by at least one of the one or more combinations of the plurality of recipient attributes; produce a set of at least one trust assessment based on application of the predefined attribute policy to the plurality of recipient attributes; and a decryption decision engine configured to compare the at least one trust assessment against the set of at least one trust criterion and, in response to satisfaction of the set of at least one trust criterion by the at least one trust assessment, provide an access grant to a decryption engine, the access grant permitting the decryption engine to recover the protected information from cyphertext.

In Example 8, the subject matter of Example 7 optionally includes wherein the decryption engine is configured to use a decryption key to recover the protected information from the cyphertext.

In Example 9, the subject matter of any one or more of Examples 7-8 optionally include wherein the cyphertext is based on the set of at least one trust criterion.

In Example 10, the subject matter of any one or more of Examples 7-9 optionally include an attribute distiller configured to: access the predefined attribute policy; and produce the set of at least one trust criterion derived from the predefined attribute policy.

In Example 11, the subject matter of any one or more of Examples 7-10 optionally include wherein the at least one trust criterion has fewer attributes than the plurality of recipient attributes.

In Example 12, the subject matter of any one or more of Examples 7-11 optionally include wherein the attribute evaluator includes a trust assessment engine configured to: access scoring criteria that defines parameters for determining measures applicable to the combinations of the plurality of recipient attributes as defined in the at least one predefined attribute policy; and wherein the set of at least one trust assessment is further based on application of the scoring criteria to the plurality of recipient attributes.

In Example 13, the subject matter of any one or more of Examples 7-12 optionally include wherein the attribute evaluator includes a trust assessment engine configured to: access context criteria that defines various contexts; access current context information that represents an assessment of a current use context of the recipient entity; and wherein the attribute policy is a context-based attribute policy defining a plurality of different measures of trust corresponding to different contexts; and wherein the set of at least one trust assessment is further based on application of the context criteria to the current context and on an evaluation of the plurality of recipient attributes according to the context-based attribute policy.

In Example 14, the subject matter of any one or more of Examples 7-13 optionally include wherein the access grant includes a decryption key with which protected information is recoverable from the cyphertext.

In Example 15, the subject matter of any one or more of Examples 7-14 optionally include wherein the at least one trust criterion is a single trust criterion.

In Example 16, the subject matter of any one or more of Examples 7-15 optionally include wherein the at least one trust criterion includes a trust threshold value.

In Example 17, the subject matter of any one or more of Examples 7-16 optionally include a computing platform including a set of at least one processor, data storage circuitry, and input/output facilities, the computing platform configured to implement the attribute evaluator and the decryption decision engine.

In Example 18, the subject matter of any one or more of Examples 7-17 optionally include wherein the attribute evaluator is implemented in a trusted execution environment.

Example 19 is at least one machine-readable medium comprising instructions that, when executed on a computing platform, cause the computing platform to execute a process for recovering protected information protected using attribute-based encryption, the instructions to cause the computing platform to: access a plurality of recipient attributes of a recipient entity; access a predefined attribute policy that defines one or more combinations of the plurality of recipient attributes that entitle the recipient entity to attain access to the protected information; access a set of at least one trust criterion derived from the predefined attribute policy, the at least one trust criterion representing a measure of trust attainable by at least one of the one or more combinations of the plurality of recipient attributes; produce a set of at least one trust assessment based on application of the predefined attribute policy to the plurality of recipient attributes; and compare the at least one trust assessment against the set of at least one trust criterion and, in response to satisfaction of the set of at least one trust criterion by the at least one trust assessment, provide an access grant to a decryption process, the access grant permitting recovery of the protected information from cyphertext.

In Example 20, the subject matter of Example 19 optionally includes wherein the decryption process is configured to use a decryption key to recover the protected information from the cyphertext.

In Example 21, the subject matter of any one or more of Examples 19-20 optionally include wherein the cyphertext is based on the set of at least one trust criterion.

In Example 22, the subject matter of any one or more of Examples 19-21 optionally include wherein the instructions are to further cause the computing circuitry to: access the predefined attribute policy; and produce the set of at least one trust criterion derived from the predefined attribute policy.

In Example 23, the subject matter of any one or more of Examples 19-22 optionally include wherein the at least one trust criterion has fewer attributes than the plurality of recipient attributes.

In Example 24, the subject matter of any one or more of Examples 19-23 optionally include wherein the instructions are to further cause the computing platform to: access scoring criteria that defines parameters for determining measures applicable to the combinations of the plurality of recipient attributes as defined in the at least one predefined attribute policy; and wherein the set of at least one trust assessment is further based on application of the scoring criteria to the plurality of recipient attributes.

In Example 25, the subject matter of any one or more of Examples 19-24 optionally include wherein the instructions are to further cause the computing platform to: access context criteria that defines various contexts; access current context information that represents an assessment of a current use context of the recipient entity; and wherein the attribute policy is a context-based attribute policy defining a plurality of different measures of trust corresponding to different contexts; and wherein the set of at least one trust assessment is further based on application of the context criteria to the current context and on an evaluation of the plurality of recipient attributes according to the context-based attribute policy.

In Example 26, the subject matter of any one or more of Examples 19-25 optionally include wherein the access grant includes a decryption key with which protected information is recoverable from the cyphertext.

In Example 27, the subject matter of any one or more of Examples 19-26 optionally include wherein the at least one trust criterion is a single trust criterion.

In Example 28, the subject matter of any one or more of Examples 19-27 optionally include wherein the at least one trust criterion includes a trust threshold value.

Example 29 is a method for recovering protected information that is protected with attribute-based encryption, the method comprising: accessing a plurality of recipient attributes of a recipient entity; accessing a predefined attribute policy that defines one or more combinations of the plurality of recipient attributes that entitle the recipient entity to attain access to the protected information: accessing a set of at least one trust criterion derived from the predefined attribute policy, the at least one trust criterion representing a measure of trust attainable by at least one of the one or more combinations of the plurality of recipient attributes; producing a set of at least one trust assessment based on application of the predefined attribute policy to the plurality of recipient attributes; and comparing the at least one trust assessment against the set of at least one trust criterion and, in response to satisfaction of the set of at least one trust criterion by the at least one trust assessment, and providing an access grant to a decryption process, the access grant permitting recovery of the protected information from cyphertext.

In Example 30, the subject matter of Example 29 optionally includes wherein the decryption process is configured to use a decryption key to recover the protected information from the cyphertext.

In Example 31, the subject matter of any one or more of Examples 29-30 optionally include wherein the cyphertext is based on the set of at least one trust criterion.

In Example 32, the subject matter of any one or more of Examples 29-31 optionally include accessing the predefined attribute policy; and producing the set of at least one trust criterion derived from the predefined attribute policy.

In Example 33, the subject matter of any one or more of Examples 29-32 optionally include wherein the at least one trust criterion has fewer attributes than the plurality of recipient attributes.

In Example 34, the subject matter of any one or more of Examples 29-33 optionally include accessing scoring criteria that defines parameters for determining measures applicable to the combinations of the plurality of recipient attributes as defined in the at least one predefined attribute policy; and wherein the set of at least one trust assessment is further based on application of the scoring criteria to the plurality of recipient attributes.

In Example 35, the subject matter of any one or more of Examples 29-34 optionally include accessing context criteria that defines various contexts; accessing current context information that represents an assessment of a current use context of the recipient entity; and wherein the attribute policy is a context-based attribute policy defining a plurality of different measures of trust corresponding to different contexts; and wherein the set of at least one trust assessment is further based on application of the context criteria to the current context and on an evaluation of the plurality of recipient attributes according to the context-based attribute policy.

In Example 36, the subject matter of any one or more of Examples 29-35 optionally include wherein the access grant includes a decryption key with which protected information is recoverable from the cyphertext.

In Example 37, the subject matter of any one or more of Examples 29-36 optionally include wherein the at least one trust criterion is a single trust criterion.

In Example 38, the subject matter of any one or more of Examples 29-37 optionally include wherein the at least one trust criterion includes a trust threshold value.

Example 39 is at least one machine-readable medium containing instructions that, when executed by a computing platform, cause the computing platform to carry out the method according to any one of Examples 29-38.

Example 40 is a system for recovering protected information that is protected with attribute-based encryption comprising means for carrying out the method according to any one of Examples 29-38.

Example 41 is a system for recovering protected information that is protected with attribute-based encryption, the system comprising: means for accessing a plurality of recipient attributes of a recipient entity; means for accessing a predefined attribute policy that defines one or more combinations of the plurality of recipient attributes that entitle the recipient entity to attain access to the protected information: means for accessing a set of at least one trust criterion derived from the predefined attribute policy, the at least one trust criterion representing a measure of trust attainable by at least one of the one or more combinations of the plurality of recipient attributes; means for producing a set of at least one trust assessment based on application of the predefined attribute policy to the plurality of recipient attributes; and means for comparing the at least one trust assessment against the set of at least one trust criterion and, in response to satisfaction of the set of at least one trust criterion by the at least one trust assessment, and means for for providing an access grant to a decryption process, the access grant permitting recovery of the protected information from cyphertext.

In Example 42, the subject matter of Example 41 optionally includes wherein the decryption process is configured to use a decryption key to recover the protected information from the cyphertext.

In Example 43, the subject matter of any one or more of Examples 41-42 optionally include wherein the cyphertext is based on the set of at least one trust criterion.

In Example 44, the subject matter of any one or more of Examples 41-43 optionally include means for accessing the predefined attribute policy; and means for producing the set of at least one trust criterion derived from the predefined attribute policy.

In Example 45, the subject matter of any one or more of Examples 41-44 optionally include wherein the at least one trust criterion has fewer attributes than the plurality of recipient attributes.

In Example 46, the subject matter of any one or more of Examples 41-45 optionally include means for accessing scoring criteria that defines parameters for determining measures applicable to the combinations of the plurality of recipient attributes as defined in the at least one predefined attribute policy; and wherein the set of at least one trust assessment is further based on application of the scoring criteria to the plurality of recipient attributes.

In Example 47, the subject matter of any one or more of Examples 41-46 optionally include means for accessing context criteria that defines various contexts; means for accessing current context information that represents an assessment of a current use context of the recipient entity; and wherein the attribute policy is a context-based attribute policy defining a plurality of different measures of trust corresponding to different contexts; and wherein the set of at least one trust assessment is further based on application of the context criteria to the current context and on an evaluation of the plurality of recipient attributes according to the context-based attribute policy.

In Example 48, the subject matter of any one or more of Examples 41-47 optionally include wherein the access grant includes a decryption key with which protected information is recoverable from the cyphertext.

In Example 49, the subject matter of any one or more of Examples 41-48 optionally include wherein the at least one trust criterion is a single trust criterion.

In Example 50, the subject matter of any one or more of Examples 41-49 optionally include wherein the at least one trust criterion includes a trust threshold value.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document: for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third.” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for protecting information with attribute-based encryption, the system comprising:
an attribute distiller configured to:
access a predefined attribute policy that defines one or more combinations of a plurality of recipient attributes that entitle a recipient entity to attain access to protected information; and
produce a set of at least one trust criterion derived from the predefined attribute policy, the at least one trust criterion representing a measure of trust attainable by at least one of the one or more combinations of the plurality of recipient attributes, the at least one trust criterion having fewer attributes than the plurality of recipient attributes; and
an encryptor configured to encrypt the information to produce cyphertext, the cyphertext being based on the at least one trust criterion.

2. The system of claim 1, wherein the attribute policy is a context-based attribute policy defining a plurality of different measures of trust corresponding to different contexts.

3. The system of claim 1, wherein the attribute distiller is implemented in a trusted execution environment.

4. A system for recovering protected information that is protected with attribute-based encryption, the system comprising:
an attribute evaluator configured to:
access a plurality of recipient attributes of a recipient entity;
access a predefined attribute policy that defines one or more combinations of the plurality of recipient attributes that entitle the recipient entity to attain access to the protected information; and
access a set of at least one trust criterion derived from the predefined attribute policy, the at least one trust criterion representing a measure of trust attainable by at least one of the one or more combinations of the plurality of recipient attributes;
produce a set of at least one trust assessment based on application of the predefined attribute policy to the plurality of recipient attributes; and
a decryption decision engine configured to compare the at least one trust assessment against the set of at least one trust criterion and, in response to satisfaction of the set of at least one trust criterion by the at least one trust assessment, provide an access grant to a decryption engine, the access grant permitting the decryption engine to recover the protected information from cyphertext.

5. The system of claim 4, wherein the decryption engine is configured to use a decryption key to recover the protected information from the cyphertext.

6. The system of claim 4, wherein the cyphertext is based on the set of at least one trust criterion.

7. The system of claim 4, further comprising:
an attribute distiller configured to:
access the predefined attribute policy; and
produce the set of at least one trust criterion derived from the predefined attribute policy.

8. The system of claim 4, wherein the at least one trust criterion has fewer attributes than the plurality of recipient attributes.

9. The system of claim 4, wherein the attribute evaluator includes a trust assessment engine configured to:
access scoring criteria that defines parameters for determining measures applicable to the combinations of the plurality of recipient attributes as defined in the at least one predefined attribute policy; and
wherein the set of at least one trust assessment is further based on application of the scoring criteria to the plurality of recipient attributes.

10. The system of claim 4, wherein the attribute evaluator includes a trust assessment engine configured to:
access context criteria that defines various contexts;
access current context information that represents an assessment of a current use context of the recipient entity; and
wherein the attribute policy is a context-based attribute policy defining a plurality of different measures of trust corresponding to different contexts; and
wherein the set of at least one trust assessment is further based on application of the context criteria to the current context and on an evaluation of the plurality of recipient attributes according to the context-based attribute policy.

11. The system of claim 4, wherein the access grant includes a decryption key with which protected information is recoverable from the cyphertext.

12. The system of claim 4, wherein the at least one trust criterion is a single trust criterion.

13. The system of claim 4, wherein the at least one trust criterion includes a trust threshold value.

14. The system of claim 4, further comprising:
a computing platform including a set of at least one processor, data storage circuitry, and input/output facilities, the computing platform configured to implement the attribute evaluator and the decryption decision engine.

15. The system of claim 4, wherein the attribute evaluator is implemented in a trusted execution environment.

16. At least one machine-readable medium comprising instructions that, when executed on a computing platform, cause the computing platform to execute a process for recovering protected information protected using attribute-based encryption, the instructions to cause the computing platform to:
access a plurality of recipient attributes of a recipient entity;
access a predefined attribute policy that defines one or more combinations of the plurality of recipient attributes that entitle the recipient entity to attain access to the protected information;
access a set of at least one trust criterion derived from the predefined attribute policy, the at least one trust criterion representing a measure of trust attainable by at least one of the one or more combinations of the plurality of recipient attributes;
produce a set of at least one trust assessment based on application of the predefined attribute policy to the plurality of recipient attributes; and
compare the at least one trust assessment against the set of at least one trust criterion and, in response to satisfaction of the set of at least one trust criterion by the at least one trust assessment, provide an access grant to a decryption process, the access grant permitting the decryption engine to recover the protected information from cyphertext.

17. The at least one machine-readable medium of claim 16, wherein the instructions are to further cause the computing platform to:
access scoring criteria that defines parameters for determining measures applicable to the combinations of the plurality of recipient attributes as defined in the at least one predefined attribute policy; and
wherein the set of at least one trust assessment is further based on application of the scoring criteria to the plurality of recipient attributes.

18. The at least one machine-readable medium of claim 16, wherein the instructions are to further cause the computing platform to:
access context criteria that defines various contexts; and
access current context information that represents an assessment of a current use context of the recipient entity;
wherein the attribute policy is a context-based attribute policy defining a plurality of different measures of trust corresponding to different contexts; and
wherein the set of at least one trust assessment is further based on application of the context criteria to the current context and on an evaluation of the plurality of recipient attributes according to the context-based attribute policy.

19. A method for recovering protected information that is protected with attribute-based encryption, the method comprising:
accessing a plurality of recipient attributes of a recipient entity;
accessing a predefined attribute policy that defines one or more combinations of the plurality of recipient attributes that entitle the recipient entity to attain access to the protected information;
accessing a set of at least one trust criterion derived from the predefined attribute policy, the at least one trust criterion representing a measure of trust attainable by at least one of the one or more combinations of the plurality of recipient attributes;
producing a set of at least one trust assessment based on application of the predefined attribute policy to the plurality of recipient attributes; and
comparing the at least one trust assessment against the set of at least one trust criterion and, in response to satisfaction of the set of at least one trust criterion by the at least one trust assessment, providing an access grant to a decryption process, the access grant permitting recovery of the protected information from cyphertext.

20. The method of claim 19, wherein the cyphertext is based on the set of at least one trust criterion.

21. The method of claim 19, further comprising:
accessing the predefined attribute policy; and
producing the set of at least one trust criterion derived from the predefined attribute policy.

22. The method of claim 19, wherein the at least one trust criterion has fewer attributes than the plurality of recipient attributes.

23. The method of claim 19, further comprising:
accessing scoring criteria that defines parameters for determining measures applicable to the combinations of the plurality of recipient attributes as defined in the at least one predefined attribute policy; and
wherein the set of at least one trust assessment is further based on application of the scoring criteria to the plurality of recipient attributes.

24. The method of claim 19, further comprising:
accessing context criteria that defines various contexts;
accessing current context information that represents an assessment of a current use context of the recipient entity; and
wherein the attribute policy is a context-based attribute policy defining a plurality of different measures of trust corresponding to different contexts; and
wherein the set of at least one trust assessment is further based on application of the context criteria to the current context and on an evaluation of the plurality of recipient attributes according to the context-based attribute policy.

25. The method of claim 19, wherein the at least one trust criterion includes a trust threshold value.
